(19) United States
(12) Patent Application Publication
(10) Pub. No.: US 2019/0164685 A1
(43) Pub. Date: May 30, 2019

(54) MULTILAYER COIL COMPONENT

(71) Applicant: Murata Manufacturing Co., Ltd., Kyoto-fu (JP)

(72) Inventor: Atsuo HIRUKAWA, Nagaokakyo-shi (JP)

(73) Assignee: Murata Manufacturing Co., Ltd., Kyoto-fu (JP)

(21) Appl. No.: 16/197,135

(22) Filed: Nov. 20, 2018

(30) Foreign Application Priority Data
Nov. 27, 2017 (JP) 2017-226910

(51) Int. Cl. H01F 27/29; H01F 17/00; H01F 27/32

(52) U.S. Cl. CPC H01F 27/292; H01F 27/32; H01F 17/0013

(57) ABSTRACT

A multilayer coil component includes a multilayer body that is formed of laminated insulating layers and that contains a coil, and a first outer electrode and a second outer electrode that are electrically connected to the coil. The coil is formed of coil conductors. A first connection conductor linearly connects a part of the first outer electrode that covers the first end surface and one of the coil conductors that faces the part of the first outer electrode to each other. A second connection conductor linearly connects a part of the second outer electrode that covers the second end surface and another of the coil conductors that faces the part of the second outer electrode to each other. The first and second connection conductors overlap the coil conductors in a plan view from the lamination direction and are nearer than a central axis of the coil to a mounting surface.

### CROSS-REFERENCE TO RELATED APPLICATION

This application claims benefit of priority to Japanese Patent Application No. 2017-226910, filed Nov. 27, 2017, the entire content of which is incorporated herein by reference.

### BACKGROUND

### Technical Field

The present disclosure relates to a multilayer coil component.

### Background Art

A multilayer inductor that is disclosed, as an example of multilayer coil components, in Japanese Patent No. 3351738 includes a chip having a multilayer structure in which a coil is embedded and external terminal electrodes that are formed on a surface of the chip and that are connected to respective ends of the coil. The multilayer inductor disclosed in Japanese Patent No. 3351738 includes extended layers that include extended internal conductors. The extended internal conductors are formed in layers that differ from circling layers that include internal conductors forming the coil in the multilayer structure, are exposed from the surface of the chip substantially parallel to a center line about which the coil is wound, and are connected to end portions of the coil. The external terminal electrodes are formed on the surface substantially parallel to the center line about which the coil is wound and are connected to the extended internal conductors.

### SUMMARY

However, it has been revealed that the structure of the multilayer inductor disclosed in Japanese Patent No. 3351738 carries a risk of degradation of high-frequency characteristics in a high frequency band (for example, a band of 20 GHz or more). Specifically, it has been revealed that there is a risk of a decrease in a transmission coefficient S21 at high frequencies.

The present disclosure thus provides a multilayer coil component that has excellent high-frequency characteristics.

According to preferred embodiments of the present disclosure, a multilayer coil component includes a multilayer body that is formed of laminated insulating layers and that contains a coil, and a first outer electrode and a second outer electrode that are electrically connected to the coil. The coil is formed of coil conductors that are stacked together with the insulating layers and that are electrically connected to each other. The multilayer body has a first end surface and a second end surface that face away from each other in a length direction, a first main surface and a second main surface that face away from each other in a height direction perpendicular to the length direction, and a first side surface and a second side surface that face away from each other in a width direction perpendicular to the length direction and the height direction. The first outer electrode covers a part of the first end surface, extends from the first end surface, and covers a part of the first main surface. The second outer electrode covers a part of the second end surface, extends from the second end surface, and covers a part of the first main surface. The first main surface serves as a mounting surface. A lamination direction of the multilayer body and an axial direction of the coil are parallel to the mounting surface. The multilayer body contains a first connection conductor and a second connection conductor. The first connection conductor linearly connects a part of the first outer electrode that covers the first end surface and one of the coil conductors that faces the part of the first outer electrode to each other. The second connection conductor linearly connects a part of the second outer electrode that covers the second end surface and another of the coil conductors that faces the part of the second outer electrode to each other. The first connection conductor and the second connection conductor overlap the coil conductors in a plan view along the lamination direction and are nearer than a central axis of the coil to the mounting surface.

According to preferred embodiments of the present disclosure, the first outer electrode may further extend from the first end surface and the first main surface and cover a part of the first side surface and a part of the second side surface, and the second outer electrode may further extend from the second end surface and the first main surface and cover a part of the first side surface and a part of the second side surface.

According to preferred embodiments of the present disclosure, the coil conductors preferably overlap in a plan view from the lamination direction. According to preferred embodiments of the present disclosure, the coil preferably has a substantially circular shape in a plan view from the lamination direction.

According to preferred embodiments of the present disclosure, it is preferable that the length of the multilayer coil component be no less than 0.57 mm and no more than 0.63 mm (i.e., from 0.57 mm to 0.63 mm), and the width of the multilayer coil component be no less than 0.27 mm and no more than 0.33 mm (i.e., from 0.27 mm to 0.33 mm). According to preferred embodiments of the present disclosure, it is preferable that the height of the part of the first outer electrode that covers the first end surface be no less than 0.1 mm and no more than 0.2 mm (i.e., from 0.1 mm to 0.2 mm), and the height of the part of the second outer electrode that covers the second end surface be no less than 0.1 mm and no more than 0.2 mm (i.e., from 0.1 mm to 0.2 mm).

According to preferred embodiments of the present disclosure, it is preferable that a distance between the coil conductors in the lamination direction be no less than 3 μm and no more than 7 μm (i.e., from 3 μm to 7 μm). According to preferred embodiments of the present disclosure, it is preferable that a transmission coefficient S21 at about 40 GHz be no less than −1.0 dB and no more than 0 dB (i.e., from −1.0 dB to 0 dB). According to preferred embodiments of the present disclosure, a multilayer coil component that has excellent high-frequency characteristics can be provided.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 schematically illustrates a perspective view of a multilayer coil component according to an embodiment of the present disclosure;

FIG. 2A is a side view of the multilayer coil component illustrated in FIG. 1;

FIG. 2B is a front view of the multilayer coil component illustrated in FIG. 1;

FIG. 2C is a bottom view of the multilayer coil component illustrated in FIG. 1;

FIG. 3 schematically illustrates an exploded perspective view of an example of a multilayer body that is included in the multilayer coil component illustrated in FIG. 1;

FIG. 4 schematically illustrates an exploded plan view of the example of the multilayer body that is included in the multilayer coil component illustrated in FIG. 1;

FIG. 5A schematically illustrates a side view of an example of an internal structure of the multilayer body that is included in the multilayer coil component according to the embodiment of the present disclosure;

FIG. 5B schematically illustrates a front view of an example of a first end surface of the multilayer body that is included in the multilayer coil component according to the embodiment of the present disclosure;

FIG. 5C schematically illustrates a bottom view of an example of a first main surface of the multilayer body that is included in the multilayer coil component according to the embodiment of the present disclosure;

FIG. 6 schematically illustrates a side view of an example of an internal structure of a multilayer body included in a sample of a first comparative example;

FIG. 7 schematically illustrates a plan view of an adjusted pattern shape in the first comparative example;

FIG. 8 schematically illustrates a side view of an example of an internal structure of a multilayer body included in a sample of a second comparative example;

FIG. 9 schematically illustrates a plan view of an adjusted pattern shape in the second comparative example;

FIG. 10 schematically illustrates a method of measuring a transmission coefficient S21; and

FIG. 11 illustrates a graph of the transmission coefficient S21 in a first example, the first comparative example, and the second comparative example.

### DETAILED DESCRIPTION

A multilayer coil component according to an embodiment of the present disclosure will hereinafter be described.

The present disclosure, however, is not limited to the embodiment described below and can be appropriately changed and carried out without departing from the spirit of the present disclosure. The present disclosure includes a combination of two or more preferable features described below.

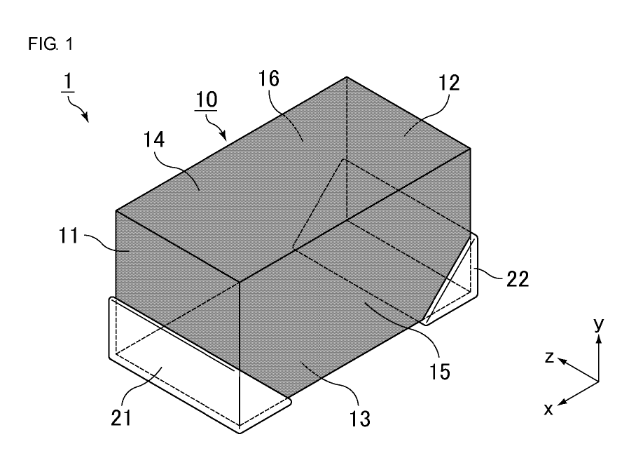

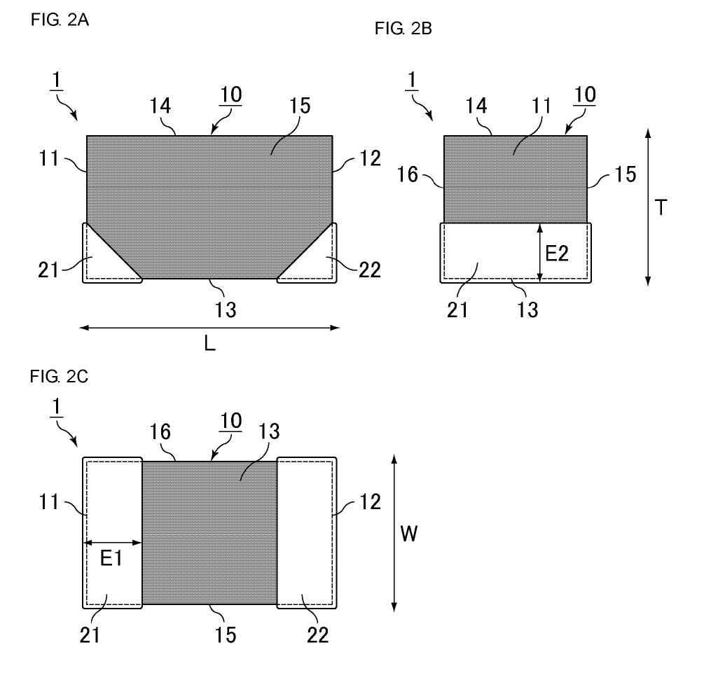

FIG. 1 schematically illustrates a perspective view of the multilayer coil component according to the embodiment of the present disclosure. FIG. 2A is a side view of the multilayer coil component illustrated in FIG. 1. FIG. 2B is a front view of the multilayer coil component illustrated in FIG. 1. FIG. 2C is a bottom view of the multilayer coil component illustrated in FIG. 1.

The multilayer coil component that is designated as 1 in FIG. 1, FIG. 2A, FIG. 2B, and FIG. 2C includes a multilayer body 10, a first outer electrode 21, and a second outer electrode 22. The multilayer body 10 has a substantially rectangular cuboid shape having six surfaces. The multilayer body 10 is formed of laminated insulating layers and contains a coil, and the structure thereof will be described later. The first outer electrode 21 and the second outer electrode 22 are electrically connected to the coil.

The length direction, the height direction, and the width direction of the multilayer coil component and the multilayer body according to the embodiment of the present disclosure correspond to the x-direction, the y-direction, and the z-direction in FIG. 1, respectively. The length direction (x-direction), the height direction (y-direction), and the width direction (z-direction) are perpendicular to each other.

As illustrated in FIG. 1, FIG. 2A, FIG. 2B, and FIG. 2C, the multilayer body 10 has a first end surface 11 and a second end surface 12 that face away from each other in the length direction (x-direction), a first main surface 13 and a second main surface 14 that face away from each other in the height direction (y-direction) perpendicular to the length direction, and a first side surface 15 and a second side surface 16 that face away from each other in the width direction (z-direction) perpendicular to the length direction and the height direction. The multilayer body 10 preferably has rounded corners and rounded ridges although this is not illustrated. At each corner, three surfaces of the multilayer body meet. Along each ridge, two surfaces of the multilayer body meet.

As illustrated in FIG. 1 and FIG. 2B, the first outer electrode 21 covers a part of the first end surface 11 of the multilayer body 10. As illustrated in FIG. 1 and FIG. 2C, the first outer electrode 21 extends from the first end surface 11 and covers a part of the first main surface 13. As illustrated in FIG. 2B, the first outer electrode 21 covers a region of the first end surface 11 that contains the ridge along which the first end surface 11 and the first main surface 13 meet but does not cover a region that contains the ridge along which the first end surface 11 and the second main surface 14 meet. Accordingly, a part of the first end surface 11 is exposed at the region that contains the ridge along which the first end surface 11 and the second main surface 14 meet. The first outer electrode 21 does not cover the second main surface 14.

In FIG. 2B, a part of the first outer electrode 21 that covers the first end surface 11 of the multilayer body 10 has a constant height. The shape of the first outer electrode 21 is not particularly limited, provided that the first outer electrode 21 covers the part of the first end surface 11 of the multilayer body 10. For example, the part of the first outer electrode 21 on the first end surface 11 of the multilayer body 10 may have a substantially arching shape that bulges from end portions toward a central portion. In FIG. 2C, a part of the first outer electrode 21 that covers the first main surface 13 of the multilayer body 10 has a constant length. The shape of the first outer electrode 21 is not particularly limited, provided that the first outer electrode 21 covers the part of the first main surface 13 of the multilayer body 10. For example, the part of the first outer electrode 21 on the first main surface 13 of the multilayer body 10 may have a substantially arching shape that bulges from end portions toward a central portion.

As illustrated in FIG. 1 and FIG. 2A, the first outer electrode 21 may further extend from the first end surface 11 and the first main surface 13 and cover a part of the first side surface 15 and a part of the second side surface 16. In this case, as illustrated in FIG. 2A, the parts of the first outer electrode 21 that cover the first side surface 15 and the second side surface 16 are preferably formed at an angle with respect to the ridges along which the first side surface 15 and the second side surface 16 meet the first end surface 11 and the first main surface 13. The first outer electrode 21 may not cover the part of the first side surface 15 and the part of the second side surface 16.

The second outer electrode 22 covers a part of the second end surface 12 of the multilayer body 10, extends from the second end surface 12, and covers a part of the first main surface 13. The second outer electrode 22 covers a region of the second end surface 12 that contains the ridge along which the second end surface 12 and the first main surface 13 meet but does not cover a region that contains the ridge along which the second end surface 12 and the second main surface 14 meet as in the first outer electrode 21. Accordingly, a part of the second end surface 12 is exposed at the region that contains along which the second end surface 12 and the second main surface 14 meet. The second outer electrode 22 does not cover the second main surface 14.

The shape of the second outer electrode 22 is not particularly limited, provided that the second outer electrode 22 covers the part of the second end surface 12 of the multilayer body 10 as in the first outer electrode 21. For example, a part of the second outer electrode 22 on the second end surface 12 of the multilayer body 10 may have a substantially arching shape that bulges from end portions toward a central portion. The shape of the second outer electrode 22 is not particularly limited, provided that the second outer electrode 22 covers the part of the first main surface 13 of the multilayer body 10. For example, a part of the second outer electrode 22 on the first main surface 13 of the multilayer body 10 may have a substantially arching shape that bulges from end portions toward a central portion.

The second outer electrode 22 may further extend from the second end surface 12 and the first main surface 13 and cover a part of the first side surface 15 and a part of the second side surface 16 as in the first outer electrode 21. In this case, the parts of the second outer electrode 22 that cover the first side surface 15 and the second side surface 16 are preferably formed at an angle with respect to the ridges along which the first side surface 15 and the second side surface 16 meet the second end surface 12 and the first main surface 13. The second outer electrode 22 may not cover the part of the first side surface 15 and the part of the second side surface 16.

Since the first outer electrode 21 and the second outer electrode 22 are thus arranged, when a multilayer coil component 1 is mounted on a substrate, the first main surface 13 of the multilayer body 10 serves as a mounting surface. The size of the multilayer coil component according to the embodiment of the present disclosure is not particularly limited but is preferably 0603 size or 0402 size so-called in the industry.

When the size of the multilayer coil component according to the embodiment of the present disclosure is the 0603 size, the length (length represented by a double-headed arrow L in FIG. 2A) of the multilayer coil component is preferably no less than 0.57 mm and no more than 0.63 mm (i.e., from 0.57 mm to 0.63 mm), and the width (length represented by a double-headed arrow W in FIG. 2C) of the multilayer coil component is preferably no less than 0.27 mm and no more than 0.33 mm (i.e., from 0.27 mm to 0.33 mm).

When the size of the multilayer coil component according to the embodiment of the present disclosure is the 0603 size, the height (length represented by a double-headed arrow T in FIG. 2B) of the multilayer coil component is preferably no less than 0.27 mm and no more than 0.33 mm (i.e., from 0.27 mm to 0.33 mm). When the size of the multilayer coil component according to the embodiment of the present disclosure is the 0603 size, the length (length represented by a double-headed arrow E1 in FIG. 2C) of the part of the first outer electrode that covers the first main surface of the multilayer body is preferably no less than 0.12 mm and no more than 0.22 mm (i.e., from 0.12 mm to 0.22 mm). Similarly, the length of the part of the second outer electrode 22 that covers the first main surface 13 of the multilayer body 10 is preferably no less than 0.12 mm and no more than 0.22 mm (i.e., from 0.12 mm to 0.22 mm).

When the length of the part of the first outer electrode 21 that covers the first main surface 13 of the multilayer body 10 and the length of the part of the second outer electrode 22 that covers the first main surface 13 of the multilayer body 10 are not constant, the maximum length is preferably within the above range.

When the size of the multilayer coil component according to the embodiment of the present disclosure is the 0603 size, the height (length represented by a double-headed arrow E2 in FIG. 2B) of the part of the first outer electrode 21 that covers the first end surface 11 of the multilayer body 10 is preferably no less than 0.1 mm and no more than 0.2 mm (i.e., from 0.1 mm to 0.2 mm). Similarly, the height of the part of the second outer electrode 22 that covers the second end surface 12 of the multilayer body 10 is preferably no less than 0.1 mm and no more than 0.2 mm (i.e., from 0.1 mm to 0.2 mm). In this case, a stray capacitance due to each outer electrode can be decreased.

The height of the part of the first outer electrode 21 that covers the first end surface 11 of the multilayer body 10 and the height of the part of the second outer electrode 22 that covers the second end surface 12 of the multilayer body 10 are not constant, the maximum height is preferably within the above range.

When the size of the multilayer coil component according to the embodiment of the present disclosure is the 0402 size, the length of the multilayer coil component is preferably no less than 0.38 mm and no more than 0.42 mm (i.e., from 0.38 mm to 0.42 mm), and the width of the multilayer coil component is preferably no less than 0.18 mm and no more than 0.22 mm (i.e., from 0.18 mm to 0.22 mm). When the size of the multilayer coil component according to the embodiment of the present disclosure is the 0402 size, the height of the multilayer coil component is preferably no less than 0.18 mm and no more than 0.22 mm (i.e., from 0.18 mm to 0.22 mm).

When the size of the multilayer coil component according to the embodiment of the present disclosure is the 0402 size, the length of the part of the first outer electrode that covers the first main surface of the multilayer body is preferably no less than 0.08 mm and no more than 0.15 mm (i.e., from 0.08 mm to 0.15 mm). Similarly, the length of the part of the second outer electrode 22 that covers the first main surface 13 of the multilayer body 10 is preferably no less than 0.08 mm and no more than 0.15 mm (i.e., from 0.08 mm to 0.15 mm).

When the size of the multilayer coil component according to the embodiment of the present disclosure is the 0402 size, the height of the part of the first outer electrode 21 that covers the first end surface 11 of the multilayer body 10 is preferably no less than 0.06 mm and no more than 0.13 mm (i.e., from 0.06 mm to 0.13 mm). Similarly, the height of the part of the second outer electrode 22 that covers the second end surface 12 of the multilayer body 10 is preferably no less than 0.06 mm and no more than 0.13 mm (i.e., from 0.06 mm to 0.13 mm). In this case, the stray capacitance due to each outer electrode can be decreased.

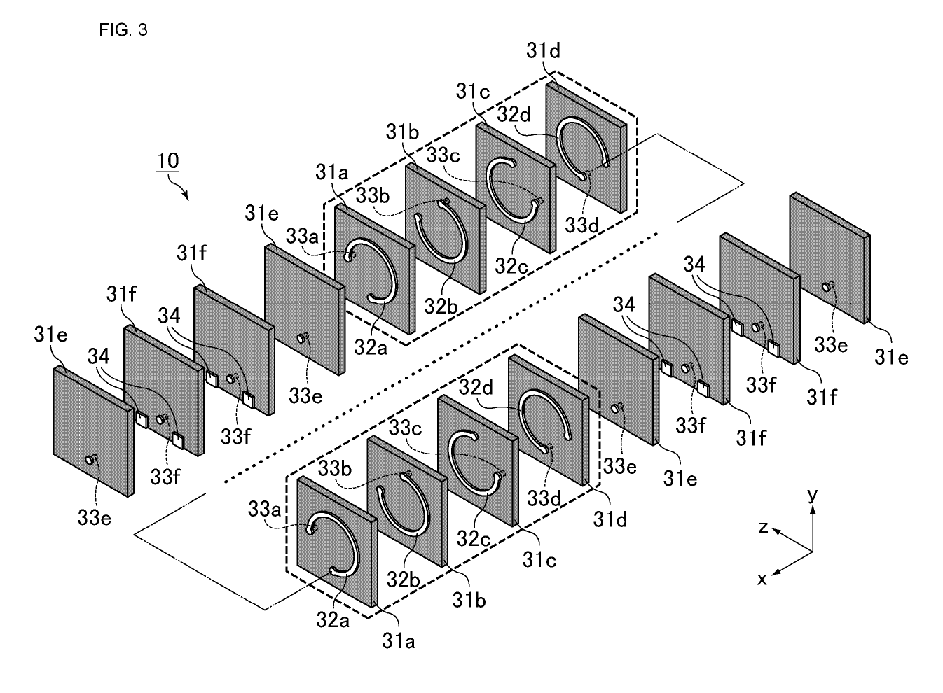

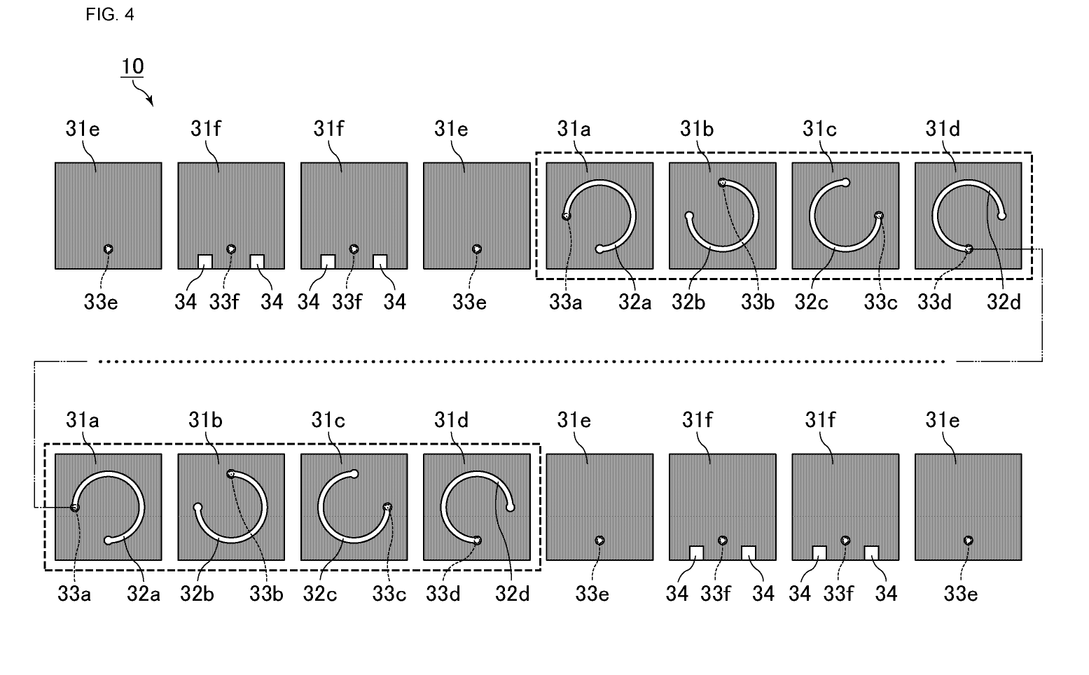

FIG. 3 schematically illustrates an exploded perspective view of an example of the multilayer body 10 that is included in the multilayer coil component illustrated in FIG. 1. FIG. 4 schematically illustrates an exploded plan view of the example of the multilayer body 10 that is included in the multilayer coil component illustrated in FIG. 1.

As illustrated in FIG. 3 and FIG. 4, the multilayer body 10 is formed of insulating layers 31a, 31b, 31c, 31d, 31e, and 31f that are laminated in the length direction (x-direction). The insulating layers 31f are not essential. The direction in which the insulating layers that are included in the multilayer body are laminated is referred to as a lamination direction.

The insulating layers 31a, 31b, 31c, and 31d include respective coil conductors 32a, 32b, 32c, and 32d, and respective via conductors 33a, 33b, 33c, and 33d. Each insulating layer 31e include a via conductor 33e. Each insulating layer 31f includes a via conductor 33f and mark conductor patterns 34.

The coil conductors 32a, 32b, 32c, and 32d are disposed on main surfaces of the corresponding insulating layers 31a, 31b, 31c, and 31d and are stacked together with the insulating layers 31a, 31b, 31c, 31d, 31e, and 31f. As illustrated in FIG. 3 and FIG. 4, each coil conductor has a ¾ turn shape and is stacked, and a combination of the insulating layers 31a, 31b, 31c, and 31d is regarded as a unit (for three turns).

The via conductors 33a, 33b, 33c, 33d, 33e, and 33f extend through the insulating layers 31a, 31b, 31c, 31d, 31e, and 31f in the thickness direction (x-direction in FIG. 3), respectively. Lands that are connected to the via conductors are typically disposed on the main surfaces of the insulating layers. The size of each land is preferably slightly more than the line width of each coil conductor.

The mark conductor patterns 34 are formed on the main surfaces of the insulating layers 31f. In FIG. 3 and FIG. 4, the mark conductor patterns 34 are formed in two regions of the main surface of each insulating layer 31f and are in contact with an outer circumferential edge of the insulating layer 31f.

The insulating layers 31a, 31b, 31c, 31d, 31e, and 31f that have the above structure are laminated in the X-direction as illustrated in FIG. 3. Thus, the coil conductors 32a, 32b, 32c, and 32d are electrically connected to each other with the via conductors 33a, 33b, 33c, and the 33d interposed therebetween. Consequently, a solenoid coil that has a coil axis extending in the x-direction is formed in the multilayer body 10.

In the multilayer body 10, the via conductors 33e and 33f form connection conductors, which are exposed from respective end surfaces of the multilayer body 10. In the multilayer body 10, each connection conductor linearly connects the first outer electrode 21 and the coil conductor 32a that faces the first outer electrode 21 or linearly connects the second outer electrode 22 and the coil conductor 32d that faces the second outer electrode 22. The mark conductor patterns 34 are exposed from the first main surface 13 of the multilayer body 10 and serve as determination marks 50.

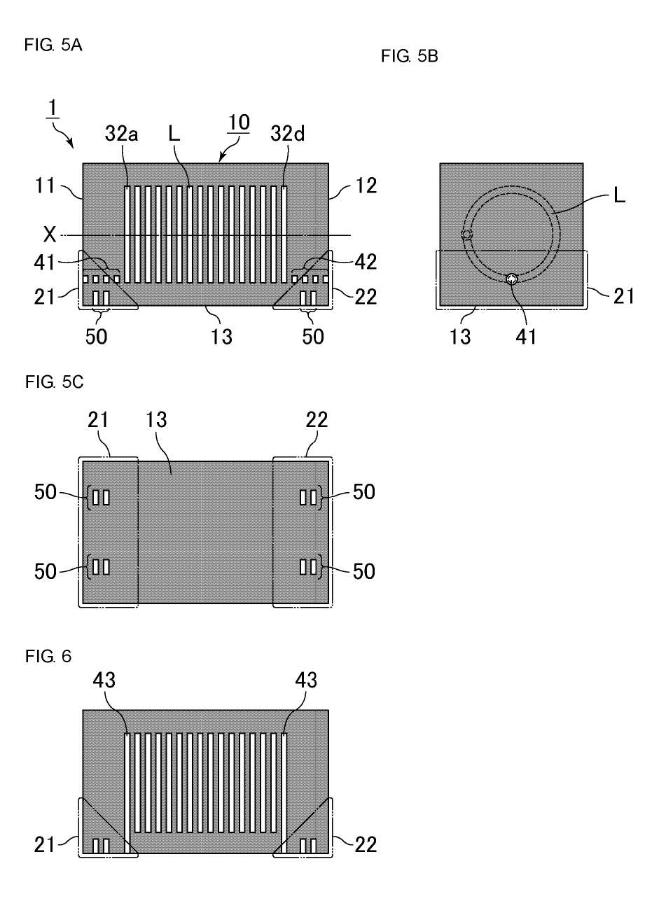

FIG. 5A schematically illustrates a side view of an example of an internal structure of the multilayer body 10 that is included in the multilayer coil component according to the embodiment of the present disclosure. FIG. 5B schematically illustrates a front view of an example of the first end surface 11 of the multilayer body 10 that is included in the multilayer coil component according to the embodiment of the present disclosure. FIG. 5C schematically illustrates a bottom view of an example of the first main surface 13 of the multilayer body 10 that is included in the multilayer coil component according to the embodiment of the present disclosure. FIG. 5A schematically illustrates the positional relationship among the coil, the connection conductors, and the determination marks 50, and the lamination direction of the multilayer body 10 but does not strictly illustrate actual shapes and connections. For example, the coil conductors that form the coil are connected to each other with the via conductors interposed therebetween. The via conductors that form the connection conductors are connected to each other.

As illustrated in FIG. 5A, the lamination direction of the multilayer body 10 of the multilayer coil component 1 and the axial direction of a coil L (corresponding to the central axis X of the coil L in FIG. 5A) are parallel to the first main surface 13 that serves as the mounting surface. In the multilayer body 10, a first connection conductor 41 linearly connects the part of the first outer electrode 21 that covers the first end surface 11 and the coil conductor 32a that faces the first outer electrode 21. Similarly, in the multilayer body 10, a second connection conductor 42 linearly connects the part of the second outer electrode 22 that covers the second end surface 12 and the coil conductor 32d that faces the second outer electrode 22.

As a result of the coil and the outer electrodes being linearly connected, extended portions can be simple, and the high-frequency characteristics can be improved. In the case where the via conductors that form the connection conductors overlap in a plan view from the lamination direction, the via conductors that form the connection conductors may not be strictly arranged linearly.

As illustrated in FIG. 5B, the first connection conductor 41 overlaps the coil conductors that form the coil L in a plan view from the lamination direction. As illustrated in FIG. 5A, the first connection conductor 41 is nearer than the central axis X of the coil L to the first main surface 13 that serves as the mounting surface. Similarly, the second connection conductor 42 overlaps the coil conductors that form the coil L in a plan view from the lamination direction and is nearer than the central axis X of the coil L to the first main surface 13 that serves as the mounting surface.

In FIG. 5A and FIG. 5B, the first connection conductor 41 and the second connection conductor 42 overlap the coil conductors that form the coil L in a plan view from the lamination direction so as to be nearest to the first main surface 13. However, the position of the first connection conductor 41 is not particularly limited, provided that the first connection conductor 41 overlaps the coil conductors that form the coil L in a plan view from the lamination direction and is connected to the first outer electrode 21. Similarly, the position of the second connection conductor 42 is not particularly limited, provided that the second connection conductor 42 overlaps the coil conductors that form the coil L in a plan view from the lamination direction and is connected to the second outer electrode 22. In FIG. 5A, the first connection conductor 41 and the second connection conductor 42 overlap in a plan view from the lamination direction. However, the first connection conductor 41 and the second connection conductor 42 may not overlap.

As illustrated in FIG. 5B, the coil conductors that form the coil L preferably overlap in a plan view from the lamination direction. The shape of the coil L in a plan view from the lamination direction is preferably substantially circular. When the coil L includes the lands, the shape of the coil L means the shape except for the lands.

Determination marks 50 are formed at locations of a surface of the multilayer body 10 at which the first outer electrode 21 and the second outer electrode 22 are formed. In FIG. 5A and FIG. 5C, the determination marks 50 are formed on the first main surface 13 of the multilayer body 10.

The determination marks 50 that are formed on the surface of the multilayer body 10 enable locations at which the outer electrodes are to be formed to be readily determined. This enables automatic determination with, for example, a sensor.

The determination marks 50 are preferably formed on the first main surface of the multilayer body 10. However, the determination marks 50 may be formed on the first end surface 11 or the second end surface 12 or may be formed on the first side surface or the second side surface, provided that the locations thereof are the same as the locations at which the first outer electrode 21 and the second outer electrode 22 are formed.

In an example illustrated in FIG. 5C, the determination marks 50 are formed in four regions each of which contains a corresponding one of the corners of the first main surface 13 such that each determination mark is composed of two lines. Each determination mark may be composed of one line or three lines or more. In the case where the determination marks 50 are formed at plural regions, the number of the lines of each determination mark may be the same or may differ.

The length (dimension in the width direction of the multilayer body) of the lines of the determination marks 50 is not particularly limited but is preferably no less than 0.04 mm and no more than 0.1 mm (i.e., from 0.04 mm to 0.1 mm). The width (dimension in the length direction of the multilayer body) and shape of the lines, for example, are not particularly limited.

The determination marks 50 may be formed on the insulating layers so as to be exposed from a surface of the multilayer body 10 or may be formed on the surface of the multilayer body 10 after the insulating layers are laminated. However, the determination marks 50 are preferably formed on the insulating layers. In other words, the determination marks 50 preferably extend from the inside of the multilayer body 10 and are preferably formed on the surface of the multilayer body 10.

In particular, each determination mark 50 is preferably formed of a conductor pattern that is formed on the corresponding insulating layer. In this case, the conductor pattern is formed so as to be in contact with an outer circumferential edge of the insulating layer. This enables a contact portion of the conductor pattern to be exposed from the multilayer body 10, and the determination mark 50 can be readily formed. The material of each determination mark 50 is not particularly limited, and examples thereof may include a nonconductive material such as a ceramic material.

The multilayer coil component according to the embodiment of the present disclosure may include no determination marks.

The structure of the multilayer body 10 of the multilayer coil component according to the embodiment of the present disclosure is not limited to the structure illustrated in FIG. 3 and FIG. 4. For example, the shape of the coil conductors that are included in the insulating layers 31a, 31b, 31c, and 31d or the shape of the mark conductor patterns that are included in the insulating layers 31f can be appropriately changed. The number and order of the insulating layers 31e and 31f that are laminated outside the coil can be appropriately changed. The insulating layers 31f are not essential.

When the size of the multilayer coil component according to the embodiment of the present disclosure is the 0603 size, the distance between the coil conductors in the lamination direction is preferably no less than 3 μm and no more than 7 μm (i.e., from 3 μm to 7 μm). When the distance between the coil conductors in the lamination direction is no less than 3 μm and no more than 7 pm (i.e., from 3 μm to 7 μm), the number of turns of the coil can be increased, an electrostatic capacity between the coil conductors decreases, and the impedance can be increased. In addition, a transmission coefficient S21 at high frequencies, described later, can be decreased.

The first connection conductor 41 and the second connection conductor 42 described above feature the multilayer coil component according to the embodiment of the present disclosure. The multilayer coil component has excellent high-frequency characteristics in a high frequency band, particularly, in a band of no less than 30 GHz and no more than 80 GHz (i.e., from 30 GHz to 80 GHz). Accordingly, the multilayer coil component is preferably used for, for example, a bias-tee circuit in an optical communication circuit.

The transmission coefficient S21 at about 40 GHz is evaluated as the high-frequency characteristics of the multilayer coil component according to the embodiment of the present disclosure. The transmission coefficient S21 is calculated from a ratio of power of a transmission signal to an input signal. The transmission coefficient S21 is basically a dimensionless quantity and is typically expressed by a unit of dB with a common logarithm.

The transmission coefficient S21 of the multilayer coil component according to the embodiment of the present disclosure at about 40 GHz is preferably no less than −1.0 dB and no more than 0 dB (i.e., from 1.0 dB to 0 dB).

An example of a method of manufacturing the multilayer coil component according to the embodiment of the present disclosure will now be described.

A ceramic green sheet for the insulating layers is first manufactured. For example, an organic binder such as a polyvinyl butyral resin, an organic solvent such as ethanol or toluene, and a dispersant are added in a ferrite material and kneaded to form a slurry. Subsequently, a magnetic sheet having a thickness of about 12 μm is obtained by, for example, a doctor blade method.

After oxidizable materials such as iron, nickel, zinc, and copper are mixed as ferrite materials and are pre-fired at about 800° C. for about 1 hour, the materials are pulverized with a ball mill and dried. Consequently, a Ni—Zn—Cu ferrite material (powder of mixed oxides) having an average particle diameter of about 2 μm can be obtained.

Examples of the material of the ceramic green sheet for the insulating layers can include a magnetic material such as a ferrite material, and a non-magnetic material such as a glass ceramic material, and a mixed material of these magnetic materials and/or the non-magnetic materials. When the ceramic green sheet is manufactured with a ferrite material, to achieve a high L value (inductance), the ceramic green sheet is preferably manufactured with a ferrite material that is composed of Fe₂O₃ in an amount of no less than 40 mol % and no more than 49.5 mol % (i.e., from 40 mol % to 49.5 mol %), ZnO in an amount of no less than 5 mol % and no more than 35 mol % (i.e., from 5 mol % to 35 mol %), CuO in an amount of no less than 4 mol % and no more than 12 mol % (i.e., from 4 mol % to 12 mol %), and a rest of NiO and a small amount of additive (containing inevitable impurities).

Via holes having a diameter of no less than about 20 μm and no more than about 30 μm (i.e., from about 20 μm to about 30 μm) are formed in the manufactured ceramic green sheet by a predetermined laser process. A via hole that is formed in a specific sheet is filled with an Ag paste. Conductor patterns (coil conductors) each having a thickness of about 11 μm for coil circling with ¾ turns are formed by screen printing. After drying, coil sheets are obtained.

After cutting, the coil sheets are stacked such that the coil having a winding axis parallel to the mounting surface is formed in a multilayer body. The via conductors that form the connection conductors are formed in via sheets, and the via sheets are stacked. At least one of the sheets includes the mark conductor pattern for the mark as needed.

After the multilayer body 10 is subjected to thermo-compression bonding to obtain a bonded body having a thickness of about 0.67 mm, the bonded body is cut with chip dimensions of a length of about 0.67 mm, a width of about 0.34 mm, a height of about 0.34 mm to obtain individual chips. The individual chips may be processed with a rotating barrel to round the corners and ridges thereof.

A fired body (multilayer body) that contains the coil is obtained by a binder removing process and a firing process at a predetermined temperature for a period of time each.

An Ag paste is elongated to have a predetermined thickness to form a layer, and the chip is obliquely inserted into the layer and baked to form underlying electrodes for the outer electrodes on four surfaces (a main surface, an end surface, and side surfaces) of the multilayer body 10.

The above method enables the underlying electrodes to be formed at a time unlike the case where the underlying electrodes are formed on the main surface and end surface of the multilayer body 10 at two times.

Ni films and Sn films that have predetermined thicknesses are successively formed on the underlying electrodes by plating to form the outer electrodes. In this way, the multilayer coil component according to the embodiment of the present disclosure can be manufactured.

### EXAMPLES

In the following examples, the multilayer coil component according to the embodiment of the present disclosure will be described in more detail. The present disclosure, however, is not limited to the example.

### Manufacture of Samples

### First Example

(1) A ferrite material (pre-fired powder) having a predetermined composition was prepared.

(2) The pre-fired powder, an organic binder (polyvinyl butyral resin), an organic solvent (ethanol and toluene), and a PSZ ball were put in a pot mill, sufficiently mixed, and pulverized in a wet manner to prepare a magnetic slurry.

(3) The magnetic slurry was molded into a sheet by a doctor blade method. Rectangular magnetic sheets each having a thickness of about 15 μm were manufactured by being punched out from the sheet.

(4) A conductive paste containing Ag powder and an organic vehicle for internal conductors was prepared.

(5) Manufacture of Via Sheet

The magnetic sheets were irradiated with a laser beam at predetermined locations to form via holes. The via holes were filled with the conductive paste. The conductive paste was applied around the via holes into a substantially circular shape by screen printing to form via conductors.

(6) Manufacture of Via Sheet with Mark

Via conductors were formed in the same manner as in the above (5). Mark conductor patterns for the determination marks were formed by printing.

(7) Manufacture of Coil Sheet

After the via holes were formed and filled with the conductive paste to form the via conductors, coil conductors were formed by printing.

(8) The predetermined number of the sheets were stacked in the order illustrated in FIG. 3, heated, and pressurized to manufacture a multilayer laminated body.

(9) The multilayer laminated body was put in a furnace. In the atmosphere, a binder removing process was performed at a temperature of about 500° C. in the atmosphere, subsequently, a multilayer body (fired body) was manufactured by firing at a temperature of about 900° C.

(10) A conductive paste containing Ag powder and glass frit for the outer electrodes was poured into a coating-film formation tank to form a coating film having a predetermined thickness. Portions of the multilayer body at which outer electrodes were to be formed were dipped into the coating film.

(11) After the dipping, underlying electrodes for the outer electrodes were formed by baking at a temperature of about 800° C.

(12) Ni films and Sn films were successively formed on the underlying electrodes by electroplating to form the outer electrodes.

In this way, a sample of a first example having the internal structure of the multilayer body illustrated in FIG. 5A was manufactured.

### First Comparative Example

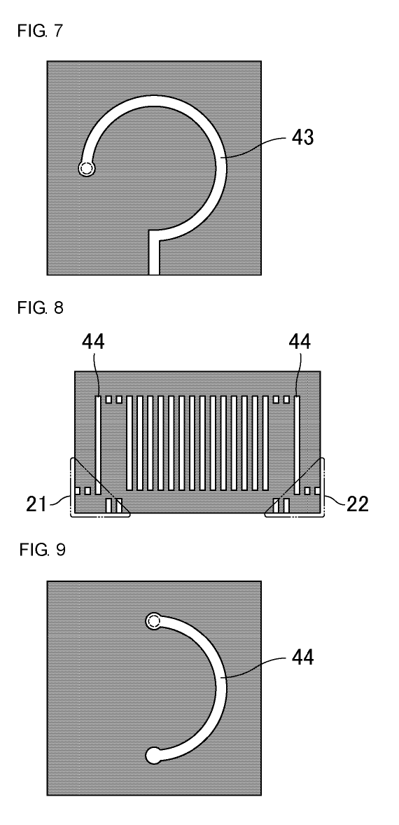

FIG. 6 schematically illustrates a side view of an example of an internal structure of a multilayer body included in a sample of a first comparative example. FIG. 7 schematically illustrates a plan view of an adjusted pattern shape in the first comparative example.

The sample of the first comparative example was manufactured in a manner in which an adjusted pattern 43 illustrated in FIG. 6 and FIG. 7 was used to change the positions of extensions to the outer electrodes.

### Second Comparative Example

FIG. 8 schematically illustrates a side view of an example of an internal structure of a multilayer body included in a sample of a second comparative example. FIG. 9 schematically illustrates a plan view of an adjusted pattern shape in the second comparative example.

The sample of the second comparative example was manufactured in a manner in which an adjusted pattern 44 illustrated in FIG. 8 and FIG. 9 was used to change the positions of extensions to the outer electrodes.

In the first example, the first comparative example, and the second comparative example, the number of turns of the coil of each sample was 42 turns.

### Evaluation of Samples

### Dimensions of Samples

In the first example, the first comparative example, and the second comparative example, the dimensions of 30 samples were measured with a micrometer and the average thereof was calculated. In each sample, L=0.62 mm, W=0.31 mm, T=0.31 mm, and E2=0.15 mm.

### Thickness of Magnetic Layer

In the first example, the first comparative example, and the second comparative example, the samples were covered with a resin such that a LW surface defined by the length L and the width W was exposed to the outside. A surface of the multilayer body was polished up to a substantially central portion of the multilayer body with a polisher, and an ion milling process was performed to remove a sag due to polishing. An image of the polished surface was captured with a scanning microscope (SEM) to measure the thickness of a magnetic layer (insulating layer) at a central portion. The measurement was taken on the 10 samples in each example, and the average thereof was regarded as the thickness of the magnetic layer. In each sample, the thickness of the magnetic layer was about 5 μm.

### Transmission Coefficient S21

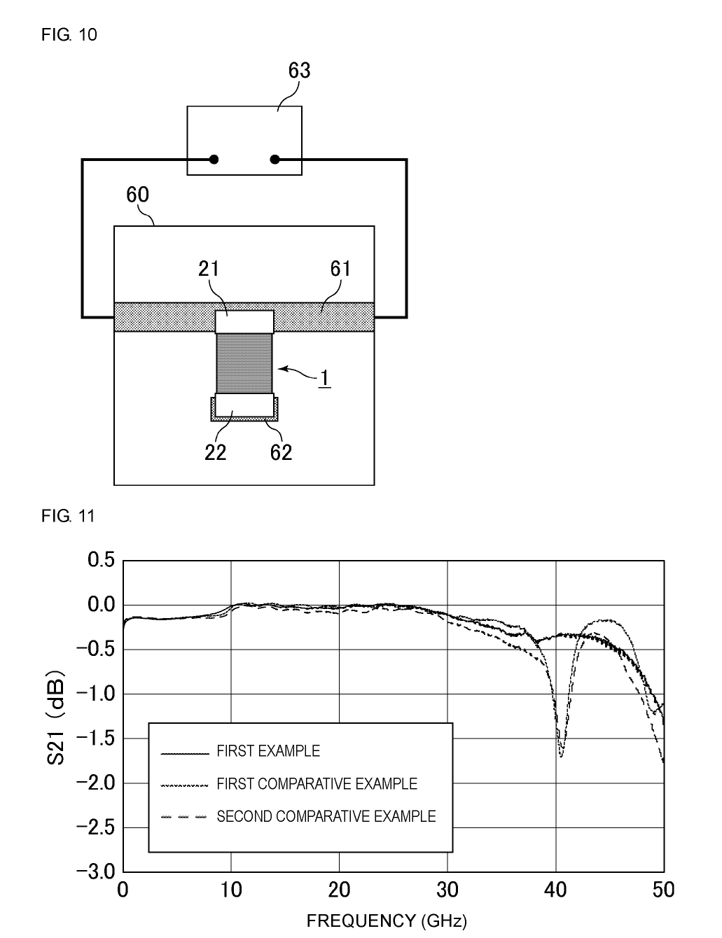

FIG. 10 schematically illustrates a method of measuring the transmission coefficient S21.

As illustrated in FIG. 10, the sample (multilayer coil component 1) was soldered to a measurement jig 60 including a signal path 61 and a ground conductor 62. The first outer electrode 21 of the multilayer coil component 1 was connected to the signal path 61. The second outer electrode 22 was connected to the ground conductor 62.

Power of the input signal to the sample and the transmission signal was obtained with a network analyzer 63, and the frequency was changed to measure the transmission coefficient S21. One terminal and the other terminal of the signal path 61 were connected to the network analyzer 63.

FIG. 11 illustrates a graph of the transmission coefficient S21 in the first example, the first comparative example, and the second comparative example. In FIG. 11, the horizontal axis represents the frequency (GHz), and the vertical axis represents S21 (dB).

The transmission coefficient S21 indicates that the closer the value thereof to zero, the less the loss. It can be seen from FIG. 11 that S21 at about 40 GHz can become approximate zero in the first example in which portions from the coil to the outer electrodes extend linearly.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A multilayer coil component comprising:
a multilayer body that is formed of laminated insulating layers and that contains a coil; and
a first outer electrode and a second outer electrode that are electrically connected to the coil,
wherein
the coil is formed of coil conductors that are stacked together with the insulating layers and that are electrically connected to each other,
the multilayer body has a first end surface and a second end surface that face away from each other in a length direction, a first main surface and a second main surface that face away from each other in a height direction perpendicular to the length direction, and a first side surface and a second side surface that face away from each other in a width direction perpendicular to the length direction and the height direction,
the first outer electrode covers a part of the first end surface, extends from the first end surface, and covers a part of the first main surface,
the second outer electrode covers a part of the second end surface, extends from the second end surface, and covers a part of the first main surface,
the first main surface serves as a mounting surface,
a lamination direction of the multilayer body and an axial direction of the coil are parallel to the mounting surface,
the multilayer body contains a first connection conductor and a second connection conductor,
the first connection conductor linearly connects a part of the first outer electrode that covers the first end surface and one of the coil conductors that faces the part of the first outer electrode to each other,
the second connection conductor linearly connects a part of the second outer electrode that covers the second end surface and another of the coil conductors that faces the part of the second outer electrode to each other, and
the first connection conductor and the second connection conductor overlap the coil conductors in a plan view from the lamination direction and are nearer than a central axis of the coil to the mounting surface.

2. The multilayer coil component according to claim 1, wherein
the first outer electrode further extends from the first end surface and the first main surface and covers a part of the first side surface and a part of the second side surface, and
the second outer electrode further extends from the second end surface and the first main surface and covers a part of the first side surface and a part of the second side surface.

3. The multilayer coil component according to claim 1, wherein
the coil conductors overlap in a plan view from the lamination direction.

4. The multilayer coil component according to claim 1, wherein
the coil has a substantially circular shape in a plan view from the lamination direction.

5. The multilayer coil component according to claim 1, wherein
a length of the multilayer coil component is from 0.57 mm to 0.63 mm, and
a width of the multilayer coil component is from 0.27 mm to 0.33 mm.

6. The multilayer coil component according to claim 5, wherein
a height of the part of the first outer electrode that covers the first end surface is from 0.1 mm to 0.2 mm, and
a height of the part of the second outer electrode that covers the second end surface is from 0.1 mm to 0.2 mm.

7. The multilayer coil component according to claim 5, wherein
a distance between the coil conductors in the lamination direction is from 3 μm to 7 μm.

8. The multilayer coil component according to claim 1, wherein
a transmission coefficient at about 40 GHz is from −1.0 dB to 0 dB.

9. The multilayer coil component according to claim 2, wherein
the coil conductors overlap in a plan view from the lamination direction.

10. The multilayer coil component according to claim 2, wherein
the coil has a substantially circular shape in a plan view from the lamination direction.

11. The multilayer coil component according to claim 3, wherein
the coil has a substantially circular shape in a plan view from the lamination direction.

12. The multilayer coil component according to claim 2, wherein
a length of the multilayer coil component is from 0.57 mm to 0.63 mm, and
a width of the multilayer coil component is from 0.27 mm to 0.33 mm.

13. The multilayer coil component according to claim 3, wherein
a length of the multilayer coil component is from 0.57 mm to 0.63 mm, and
a width of the multilayer coil component is from 0.27 mm to 0.33 mm.

14. The multilayer coil component according to claim 4, wherein
a length of the multilayer coil component is from 0.57 mm to 0.63 mm, and
a width of the multilayer coil component is from 0.27 mm to 0.33 mm.

15. The multilayer coil component according to claim 6, wherein
a distance between the coil conductors in the lamination direction is from 3 μm to 7 μm.

16. The multilayer coil component according to claim 2, wherein
a transmission coefficient at about 40 GHz is from −1.0 dB to 0 dB.

17. The multilayer coil component according to claim 3, wherein
a transmission coefficient at about 40 GHz is from −1.0 dB to 0 dB.

18. The multilayer coil component according to claim 4, wherein
a transmission coefficient at about 40 GHz is from −1.0 dB to 0 dB.

19. The multilayer coil component according to claim 5, wherein
a transmission coefficient at about 40 GHz is from −1.0 dB to 0 dB.

20. The multilayer coil component according to claim 6, wherein
a transmission coefficient at about 40 GHz is from −1.0 dB to 0 dB.
